(19) United States
(12) Patent Application Publication
(10) Pub. No.: US 2014/0114752 A1
(43) Pub. Date: Apr. 24, 2014

(54) METHOD AND SYSTEM FOR DYNAMICALLY SCREENING ADVERTISEMENT

(71) Applicant: TENCENT TECHNOLOGY (SHENZHEN) COMPANY LIMITED, Shenzhen (CN)

(72) Inventors: Weijian LI, Shenzhen (CN); Chenxiao LIU, Shenzhen (CN); Huarong DENG, Shenzhen (CN)

(73) Assignee: TENCENT TECHNOLOGY (SHENZHEN) COMPANY LIMITED, Shenzhen (CN)

(21) Appl. No.: 14/145,306

(22) Filed: Dec. 31, 2013

Related U.S. Application Data
(63) Continuation of application No. PCT/CN2013/071764, filed on Feb. 22, 2013.

(30) Foreign Application Priority Data
Mar. 13, 2012 (CN) 201210065160.2

(51) Int. Cl. G06Q 30/02

(52) U.S. Cl. CPC G06Q 30/0248
USPC 705/14.47

(57) ABSTRACT

Method and system for dynamically screening advertisement on a media are adapted to be used in the field of e-commerce. Information of at least one advertised object and/or at least one advertisement rule of the media are monitored with a monitoring unit to determine if any change occurs. If the occurrence of a change is determined, for example by the monitoring unit, information of the advertised object(s) is examined by a screening unit.

### CROSS-REFERENCE TO RELATED APPLICATION

This application claims priority to and is a continuation application of PCT/CN2013/071764, filed on Feb. 22, 2013 and entitled “METHOD AND SYSTEM FOR DYNAMICALLY SCREENING ADVERTISEMENT”, which claims the benefit of Chinese Patent Application No. 201210065160.5, filed with the Chinese Patent Office on Mar. 13, 2012 and entitled “METHOD AND SYSTEM FOR REVIEWING ADVERTISMENT”, the contents of which are incorporated herein by reference in their entirety.

### FIELD OF THE INVENTION

The present invention relates to an e-commerce technology field, and more particularly, to method and system for dynamically screening advertisement applicable to an e-commerce technology field.

### BACKGROUND OF THE INVENTION

Due to the general trend of globalization, the information service industry has become a leading industry in the 21st century, and directly or indirectly promotes the emergence and development of e-commerce. With the continuous refinement and improvement of information service industry, it is common for people to do online shopping through a variety of e-commerce platforms. Meanwhile, ads posted in the e-commerce platform for network marketing have also become a popular way to promote sellers. When a seller would like to take part in an advertising campaign, information of the merchandise or the shop itself needs to be provided. Afterwards, by way of a seller trigger system, whether the registered merchandise or shop complies with the requirements of the promotion activity is checked. The registered merchandise or shop consistent with the requirements of the promotion activity is deemed to be successfully registered, and then is further examined manually. After successfully passing the examination, the shop or merchandise may be shown on the advertising campaign.

Reviewing the technical solutions provided in accordance with the prior art, technical problems are found. In practice, the information of the registered merchandise or shop might be changed after passing the examination for the promotion activity, causing the information of the merchandise or shop no longer meets the requirements of the promotion activity. On the other hand, it is also possible that the requirements of the promotion activity are changed, causing the information of the merchandise or shop no longer meets the requirements of the promotion activity. The existing program, however, is unable to recognize the change, so some merchandises or shops actually inconsistent with the requirements are improperly shown on the advertising campaign. In summary, the absence of a regulatory mechanism for screening the existing ads might improperly advertise the disqualified merchandises or shops in the promotion activity.

### SUMMARY OF THE INVENTION

The present invention provides a mechanism for dynamically screening advertisement on a media in order to solve the problems of showing improper advertised objects on the media due to absence of monitoring mechanism.

In one aspect, the present invention provides a method for dynamically screening advertisement on a media, performed by an automatic data-processing system, which comprises steps of: monitoring information of at least one of an advertisement rule of the media and an advertised object complying with the advertisement rule to determine if any change occurs in the advertisement rule and/or the advertised object at a detection time point; reviewing information of the advertised object presented at the detection time point if the monitoring result shows that a change occurs in the advertisement rule and/or the advertised object; and disqualifying the advertised object for advertisement on the media if the reviewing result shows that the advertised object presented at the detection time point does not comply with the advertisement rule presented at the detection time point.

In another aspect, the present invention provides a system for dynamically screening advertisement on a media, which includes a monitoring unit and a screening unit. The monitoring unit monitors information of at least one of an advertisement rule of the media and an advertised object complying with the advertisement rule to determine if any change occurs in the advertisement rule and/or the advertised object at a detection time point. The screening unit reviews information of the advertised object presented at the detection time point if the monitoring result shows that a change occurs in the advertisement rule and/or the advertised object, and disqualifies the advertised object for advertisement on the media if the reviewing result shows that the advertised object presented at the detection time point does not comply with the advertisement rule presented at the detection time point.

In an embodiment of the present invention, one or both of the advertised object and the advertisement rule are monitored, and the review of the advertised object is triggered by a change of the advertised object and/or a change of the advertisement rule. Accordingly, the advertised object becoming improper can be screened out and it is assured that the advertised object(s) be the one(s) complying with advertisement rule(s) of the media.

### BRIEF DESCRIPTION OF THE DRAWINGS

In order to describe the embodiments of the present invention more clearly, the accompanying drawings required for describing the embodiments are briefly introduced hereinafter. It is apparent that the accompanying drawings are only used for illustrating some of the embodiments of the present invention, and for those ordinarily skilled in the art, further drawings can be realized without additional inventive efforts.

FIG. 1 is a flowchart of a method for dynamically screening advertisement according to a first embodiment of the present invention;

FIG. 2 is a flowchart of a method for dynamically screening advertisement according to a second embodiment of the present invention;

FIG. 3 is a flowchart of a method for dynamically screening advertisement according to a third embodiment of the present invention;

FIG. 4 is a schematic block diagram illustrating a system for dynamically screening advertisement according to a fourth embodiment of the present invention; and

FIG. 5 is a schematic block diagram illustrating a system for dynamically screening advertisement according to a fifth embodiment of the present invention.

### DETAILED DESCRIPTION OF PREFERRED EMBODIMENTS

For illustrating the objectives, technical means and advantages of the present invention in a clearer way, the present invention is described with reference to the drawings and embodiments. It is to be understood that the embodiments are used for illustrating the present invention rather than limiting the present invention.

In an embodiment of the present invention, if information of an advertised object, e.g. a merchandise-related object or shop-related object, is changed, the updated information will be automatically extracted and reviewed by an automatic data-processing system to see if the information still complies with requirements of the promotion activity of the media. If positive, the advertisement state of the advertised object is kept unchanged. Otherwise, the system will determine that the resulting advertised object is not qualified, thereby screening advertisement. On the other hand, if it is the advertisement rule of the media changed, the states of some advertised objects might be changed from a qualified state into a disqualified state according to the updated advertisement rule of the media.

A method for dynamically screening advertisement on a media provided according to an embodiment of the present invention includes monitoring information of at least one of an advertisement rule of the media and an advertised object complying with the advertisement rule to determine if any change occurs in the advertisement rule and/or the advertised object at a detection time point; reviewing information of the advertised object presented at the detection time point if the monitoring result shows that a change occurs in the advertisement rule and/or the advertised object; and disqualifying the advertised object for advertisement on the media if the reviewing result shows that the advertised object presented at the detection time point does not comply with the advertisement rule presented at the detection time point.

Furthermore, a system for dynamically screening advertisement on a media provided according to an embodiment of the present invention includes a monitoring unit monitors information of at least one of an advertisement rule of the media and an advertised object complying with the advertisement rule to determine if any change occurs in the advertisement rule and/or the advertised object at a detection time point; and a screening unit reviewing information of the advertised object presented at the detection time point if the monitoring result shows that a change occurs in the advertisement rule and/or the advertised object, and disqualifying the advertised object for advertisement on the media if the reviewing result shows that the advertised object presented at the detection time point does not comply with the advertisement rule presented at the detection time point.

Hereinafter, a variety of embodiments feasible for practicing the invention are illustrated and exemplified.

### Embodiment 1

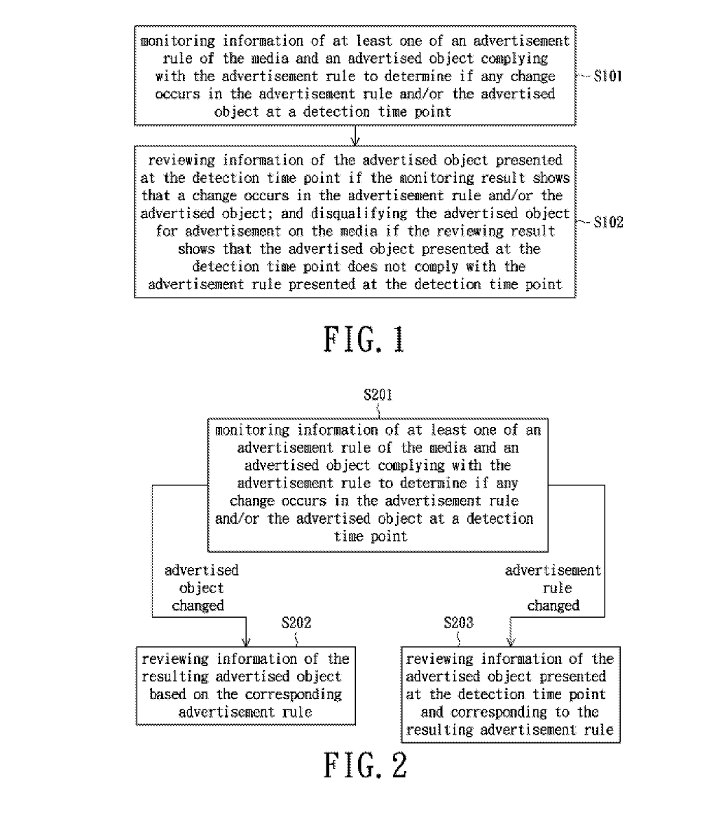

In a case that a seller shop or merchandise has been successfully registered and shown on a media due to its compliance with a specified advertisement rule of the media, the registered seller shop or merchandise are still under monitoring in this embodiment for always providing correct information to clients. When any monitored advertised object and/or advertisement rule of the media is changed, the advertised object has to be rechecked to see if it is still qualified. The method used in this embodiment is summarized by the flowchart of FIG. 1 and will be described hereinafter.

In Step S101, information of at least one of the advertised object and the advertisement rule of the media are monitored to determine if any change occurs in the advertised object and/or the advertisement rule at a detection time point.

In this embodiment, information of the advertised object having been successfully registered is checked to see if there is any change.

In this embodiment, the advertised object may be a merchandise-related object or a shop-related object. In an example that the advertised object is a shop-related object, the information of the advertised object may include, but is not limited to, credit rating of the shop, location of the shop, praise rate of the shop, conversion rate of the order-to-payment rate, trading volume, shipments scores, accuracy in description of merchandise, etc. On the other hand, if the advertised object is a merchandise-related object, the information of the advertised object may include, but is not limited to, price of the merchandise, discount of the merchandise, location of the merchandise, catalog, etc.

In this embodiment, the advertisement rule relates to the conditions required by the media on which the advertised object is to be shown. In an example that the advertised object is a shop-related object, the advertisement rule may include, but is not limited to, minimal credit rating of the shop, location of the shop within a designated area, minimal praise rate of the shop, etc. On the other hand, if the advertised object is a merchandise-related object, the advertisement rule may include, but is not limited to, price within a preset range, designated discount, etc.

Optionally, Step 101 may be executed in real time to determine if any change occurs. This monitoring mechanism is on a data-detection basis. That is, when an advertised object or advertisement rule is changed at the detection time point, an information-change message is generated and realized by the system. Accordingly, the undated information of the advertised object can be timely reviewed based on the same advertisement rule, or the information of the advertised object can be timely reviewed based on the updated advertisement rule so as to assure of the newest information shown on the media. In addition to reviewing the advertised object involving the change, it is also feasible to review partial or all the advertised objects shown on the media.

Alternatively or additionally, Step 101 may be executed at specific time points to determine if any change occurs. This monitoring mechanism is on a timing-detection basis. The advertised object(s) and advertisement rule(s) are periodically scanned to see if there is any change occurring. When there is a change determined at the detection time point, the undated information of the advertised object is reviewed based on the same advertisement rule, or the information of the advertised object is reviewed based on the updated advertisement rule so as to assure of the compliance of the advertised object with the current advertisement rule. In addition to reviewing the advertised object involving the change, it is also feasible to review partial or all the advertised objects shown on the media.

In Step 102, information of the advertised object presented at the detection time point is reviewed if the monitoring result shows that a change occurs, and the advertised object is disqualified for advertisement on the media if the reviewing result shows that the advertised object presented at the detection time point does not comply with the advertisement rule presented at the detection time point.

In this embodiment, information of the advertised object is reviewed if the monitoring result shows that a change occurs, thereby automatically screening out any advertised object which does not comply with the advertisement rule. By way of the invention, the problem resulting from arbitrarily changing information of the advertised object and the problem resulting from improperly posting advertised object inconsistent with the new advertisement rule can be prevented.

### Embodiment 2

A second embodiment of the present invention will be described hereinafter with reference to the flowchart of FIG. 2.

In Step 201, information of at least one of the advertised object and the advertisement rule of the media are monitored to determine if any change occurs in the advertised object and/or the advertisement rule at a detection time point. If a change occurs in the advertised object, Step 202 is executed. On the other hand, if a change occurs in the advertisement rule, Step 203 is executed.

In Step S202, information of the resulting advertised object is reviewed based on the corresponding advertisement rule.

In Step S203, information of the advertised object presented at the detection time point and corresponding to the resulting advertisement rule is reviewed.

In this embodiment, when it is the information of the advertised object changed, the undated information of the advertised object can be reviewed based on the same advertisement rule, thereby screening out the advertised object becoming inconsistent with the advertisement rule. On the other hand, when it is the advertisement rule of the media changed, the information of the advertised object, or partial or all the advertised objects, are examined based on the updated advertisement rule so as to screen out the advertised object becoming inconsistent with the new advertisement rule. Consequently, the compliance of the advertised object(s) with the current advertisement rule can be assured of in an automatic manner instead of a manual manner.

### Embodiment 3

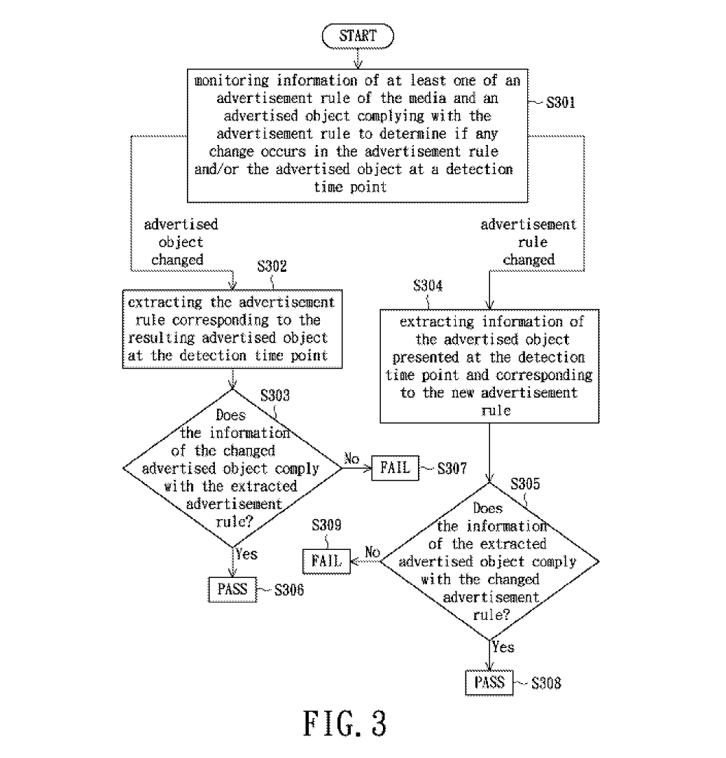

A third embodiment of the present invention will be described hereinafter with reference to the flowchart of FIG. 3.

In Step 301, information of at least one of the advertised object and the advertisement rule of the media are monitored to determine if any change occurs in the advertised object and/or the advertisement rule at a detection time point. If a change occurs in the advertised object, Step 302 is executed. On the other hand, if a change occurs in the advertisement rule, Step 304 is executed.

In Step 302, the advertisement rule corresponding to the resulting advertised object at the detection time point is extracted.

In this embodiment, the invention may further include a step of discriminating whether the advertised object having been successfully registered has posted any advertisement material or not before Step 302. If negative, Step 302 and 303 can be omitted for the advertised object having been successfully registered but having not posted any advertisement material on the media. Accordingly, the loading of the system can be alleviated.

In S303, whether the information of the changed advertised object complies with the extracted advertisement rule is discriminated. If positive, it directs to Step 306, i.e. the advertised object passes the examination. In contrast, if negative, it directs to Step 307, i.e. the advertised object fails in the examination.

In Step 304, information of the advertised object presented at the detection time point and corresponding to the new advertisement rule is extracted.

In this embodiment, a variety of advertised objects may correspond to the same advertisement rule. For example, in Tencent Store Express, the same store can have multiple ad spaces, and each advertising space corresponds to a specific advertisement rule. Furthermore, different registered ads may be shown on the same advertising space. Accordingly, when the advertisement rule is changed, information of the associated advertised object(s) corresponding to the new advertisement rule is extracted.

In S305, whether the information of the extracted advertised object complies with the changed advertisement rule is determined. If positive, it directs to Step 308, i.e. the advertised object passes the examination. In contrast, if negative, it directs to Step 309, i.e. the advertised object fails in the examination.

In this embodiment, when it is the information of the advertised object changed, whether the advertised object passes the examination is determined by discriminating whether the changed advertised object complies with the advertisement rule. On the other hand, when it is the advertisement rule of the media changed, whether the advertised object passes the examination is determined by discriminating whether the advertised object correspond to the advertisement rule complies with the changed advertisement rule. The advertised object failing in the examination is disqualified for advertisement on the media, and should be asked for withdrawal or revision. Thus the compliance of the advertised object(s) with the current advertisement rule can be automatically assured of.

### Embodiment 4

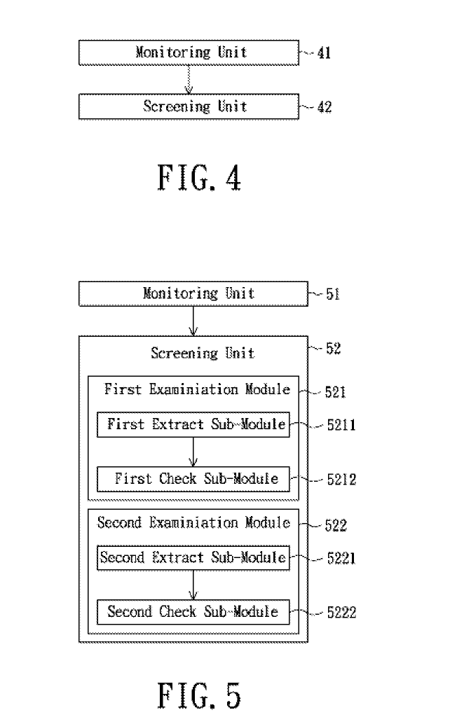

A schematic block diagram of a system for dynamically screening advertisement on a media according to a fourth embodiment is illustrated in FIG. 4.

In this embodiment, the system includes a monitoring unit 41 and a screening unit 42. The monitoring unit 41 monitors information of at least one of an advertisement rule of the media and an advertised object complying with the advertisement rule to determine if any change occurs in the advertisement rule and/or the advertised object at a detection time point. The screening unit 42 reviews information of the advertised object presented at the detection time point if the monitoring result shows that a change occurs in the advertisement rule and/or the advertised object, and disqualifies the advertised object for advertisement on the media if the reviewing result shows that the advertised object presented at the detection time point does not comply with the advertisement rule presented at the detection time point.

The system for dynamically screening advertisement on a media according to this embodiment of the present invention can be used with the method of Embodiment 1. Please see above for realizing the detailed descriptions.

In this embodiment, if the system determines there is a change occurring after monitoring information of the advertised object and/or the advertisement rule of the media, the advertised object needs be reviewed. In this manner, any advertised object which becomes inconsistent with the advertisement rule is disqualified and will be automatically screened out. By way of the invention, the problem resulting from arbitrarily changing information of the advertised object and the problem resulting from improperly posting advertised object inconsistent with the new advertisement rule can be prevented. The advertised object failing in the examination is disqualified for advertisement on the media, and should be asked for withdrawal or revision.

### Embodiment 5

A schematic block diagram of a system for dynamically screening advertisement on a media according to a fifth embodiment is illustrated in FIG. 5.

In this embodiment, the system includes a monitoring unit 51 and a screening unit 52. The monitoring unit 51 monitors information of at least one of an advertisement rule of the media and an advertised object complying with the advertisement rule to determine if any change occurs in the advertisement rule and/or the advertised object at a detection time point. The screening unit 52 reviews information of the advertised object presented at the detection time point if the monitoring result shows that a change occurs in the advertisement rule and/or the advertised object, and disqualifies the advertised object for advertisement on the media if the reviewing result shows that the advertised object presented at the detection time point does not comply with the advertisement rule presented at the detection time point.

This embodiment differs from the fourth embodiment described as above in that the information of the advertised object and/or the advertisement rule of the media can be monitored in real time to determine if any change occurs, and/or the information of at least one advertised object and at least one advertisement rule of the media can be monitored at specific time points to determine if any change occurs.

Optionally, the examination unit 52 includes a first examination module 521 and a second examination module 522. The first examination module 521 examines, when information of an advertised object is changed at the detection time point, information of the changed advertised object based on an advertisement rule of the media corresponding thereto; and the second examination module examines, when an advertisement rule of the media is changed at the detection time point, information of the advertised object corresponding to the changed advertisement rule of the media.

Optionally, the first examination module 521 includes a first extract sub-module 5211 and a first check sub-module 5212. The first extract sub-module is used for extracting an advertisement rule of the media corresponding to the information of the changed advertised object, and the first check sub-module for checking whether the information of the changed advertised object complies with the extracted advertisement rule of the media, wherein the changed advertised object complying with the extracted advertisement rule of the media is determined to pass the examination, and the changed advertised object not complying with the extracted advertisement rule of the media is determined to fail in the examination, thereby screening the disqualified advertisement. The disqualified advertised object failing in the examination for advertisement on the media should be asked for withdrawal or revision.

Optionally, the second examination module 522 includes a second extract sub-module 5221 and a second check sub-module 5222. The second extract sub-module 5221 is used for extracting information of at least one advertised object corresponding to the changed advertisement rule of the media; and the second check sub-module 5222 is used for checking whether the information of each the extracted advertised object complies with the changed advertisement rule of the media, wherein each the extracted advertised object complying with the changed advertisement rule of the media is determined to pass the examination, and each the extracted advertised object not complying with the changed advertisement rule of the media is determined to fail in the examination. The advertised object failing in the examination is disqualified for advertisement on the media, and should be asked for withdrawal or revision.

The system for screening advertisement on a media according to this embodiment of the present invention can be used with the method of Embodiment 2 and Embodiment 3. Please see above for realizing the detailed descriptions.

It is to be noted that in the above-described embodiments, all the units and modules are exemplarily classified based on functions. It is not intended to limit the classification of the units and modules to this manner as long as the corresponding functions can be achieved. Furthermore, the functional units are respectively named such that they can be clearly distinguished. The scope of the present invention is not limited thereto.

For those having ordinary skill in the art, it is understood that all or part of the steps in the various embodiments described above can be executed by a program instructing relevant hardware, and the corresponding program may be stored in a computer readable storage medium. The so-called storage medium can be, for example, a ROM/RAM, disk or optical disk, etc.

What is described above is preferred embodiments according to the present invention only rather than used for limiting the present invention. On the contrary, it is intended to cover various modifications and similar arrangements included within the spirit and scope of the appended claims which are to be accorded with the broadest interpretation so as to encompass all such modifications and similar structures.

What is claimed is:

1. A method for dynamically screening advertisement on a media, performed by an automatic data-processing system, comprising steps of:
monitoring information of at least one of an advertisement rule of the media and an advertised object complying with an advertisement rule to determine if any change occurs in the advertisement rule and/or the advertised object at a detection time point;
reviewing information of the advertised object presented at the detection time point if a monitoring result shows that a change occurs in the advertisement rule and/or the advertised object; and
disqualifying the advertised object for advertisement on a media if the reviewing result shows that the advertised object presented at the detection time point does not comply with the advertisement rule presented at the detection time point.

2. The method according to claim 1, wherein the reviewing step comprises steps of:
examining, when information of the advertised object is changed, information of the resulting advertised object based on the advertisement rule of the media corresponding thereto at the detection time point; and
examining, when the advertisement rule of the media is changed, information of the advertised object presented at the detection time point corresponding to the resulting advertisement rule of the media.

3. The method according to claim 2, wherein the examining step executed when information of the advertised object is changed comprises:
extracting the advertisement rule of the media corresponding to the information of the resulting advertised object at the detection time point; and
checking whether the information of the resulting advertised object complies with the corresponding advertisement rule of the media.

4. The method according to claim 2, wherein the examining step executed when the advertisement rule of the media is changed comprises:
extracting information of the advertised object presented at the detection time point and corresponding to the resulting advertisement rule of the media; and
checking whether the information of the advertised object presented at the detection time point complies with the resulting advertisement rule of the media.

5. The method according to claim 1, wherein the monitoring step is executed on a data-detection basis.

6. The method according to claim 5, wherein the monitoring step is further executed on a timing-detection basis.

7. The method according to claim 1, wherein the monitoring step is executed on a timing-detection basis.

8. A system for dynamically screening advertisement on a media, comprising:
a monitoring unit monitoring at least one of an advertisement rule of the media and an advertised object complying with an advertisement rule to determine if any change occurs in the advertisement rule and/or the advertised object at a detection time point; and
a screening unit reviewing information of the advertised object presented at the detection time point if the monitoring result shows that a change occurs in the advertisement rule and/or the advertised object, and disqualifying the advertised object for advertisement on the media if the reviewing result shows that the advertised object presented at the detection time point does not comply with the advertisement rule presented at the detection time point.

9. The system according to claim 8, wherein the screening unit comprises:
a first examination module examining, when information of the advertised object is changed, information of the resulting advertised object based on the advertisement rule of the media corresponding thereto at the detection time point; and
a second examination module for examining, when the advertisement rule of the media is changed, information of the advertised object presented at the detection time point corresponding to the resulting advertisement rule of the media.

10. The system according to claim 9, wherein the first examination module comprises:
a first extract sub-module extracting the advertisement rule of the media corresponding to the information of the resulting advertised object at the detection time point; and
a first check sub-module checking whether the information of the resulting advertised object complies with the corresponding advertisement rule of the media, and disqualifying the resulting advertised object for advertisement on the media if the resulting advertised object does not comply with the corresponding advertisement rule of the media at the detection time point.

11. The system according to claim 9, wherein the second examination module comprises:
a second extract sub-module extracting information of the advertised object presented at the detection time point and corresponding to the resulting advertisement rule of the media; and
a second check sub-module checking whether the information of the advertised object presented at the detection time point complies with the resulting advertisement rule of the media, and disqualifying the advertised object presented at the detection time point for advertisement on the media if the advertised object presented at the detection time point does not comply with the resulting advertisement rule of the media.

12. The system according to claim 8, wherein the monitoring unit monitors at least one of the advertisement rule of the media and the advertised object complying with the advertisement rule and determines if any change occurs on a data-detection basis.

13. The system according to claim 12, wherein the monitoring unit monitors at least one of the advertisement rule of the media and the advertised object complying with the advertisement rule and determines if any change occurs further on a timing-detection basis.

14. The system according to claim 8, wherein the monitoring unit monitors at least one of the advertisement rule of the media and the advertised object complying with the advertisement rule and determines if any change occurs on a timing-detection basis.
